(19) United States
(12) Patent Application Publication
(10) Pub. No.: US 2026/0267674 A1
(43) Pub. Date: Sep. 10, 2026

(54) INFORMATION PROCESSING DEVICE, VIRTUAL SERVICE PROVISION PROGRAM, AND COMMUNICATION METHOD

(71) Applicants: Kristopher Andrew TATE, Kyoto-shi, Kyoto (JP); connectFree Corporation, Kyoto-shi, Kyoto (JP)

(72) Inventor: Kristopher Andrew TATE, Kyoto-shi, Kyoto (JP)

(73) Assignees: Kristopher Andrew TATE, Kyoto-shi, Kyoto (JP); connectFree Corporation, Kyoto-shi, Kyoto (JP)

(21) Appl. No.: 18/876,151

(22) PCT Filed: Sep. 8, 2023
(86) PCT No.: PCT/JP2023/032861

§ 371 Date: Dec. 17, 2024

(30) Foreign Application Priority Data
Sep. 9, 2022 (JP) 2022-143917

(51) Int. Cl. G06F 9/455; H04L 67/563; H04L 67/564; H04L 69/321

(52) U.S. Cl. CPC G06F 9/45533; H04L 67/563; H04L 67/564; H04L 69/321; G06F 2009/45595

(57) ABSTRACT

An information processing device includes a communication program responsible for at least a transport layer, and a virtual service provision program capable of referring to a packet including data output from the communication program toward a lower layer. In a case where a destination address of the packet matches a specific network address that is set in advance, the virtual service provision program executes a virtual service corresponding to the packet.

### TECHNICAL FIELD

The present disclosure relates to an information processing device, a virtual service provision program, and a communication method.

### BACKGROUND ART

Typically, a plurality of processes are executed in a computer. Exchange of data between the processes is realized by using, for example, interprocess communication (IPC).

JP 2006-186610 A (Patent Document 1) discloses a configuration in which a communication board monitors another communication board by the interprocess communication.

### CITATION LIST

### PATENT DOCUMENT

Patent Document 1: JP 2006-186610 A

### SUMMARY OF THE INVENTION

### Problem to be Solved by the Invention

From the viewpoint of security, there are environments in which inquiry via interprocess communication is not permitted. The present disclosure provides a technology for providing various services in a highly versatile manner.

### Means for Solving Problem

An information processing device according to an embodiment of the present disclosure includes a communication program responsible for at least a transport layer, and a virtual service provision program capable of referring to a packet including data output from the communication program toward a lower layer. In a case where a destination address of the packet matches a specific network address that is set in advance, the virtual service provision program executes a virtual service corresponding to the packet.

The virtual service provision program may respond with at least a part of execution results of the virtual service as information.

The virtual service may include processing of transmitting data to the outside of the information processing device.

The virtual service provision program may have a plurality of the specific network addresses.

The virtual service provision program may have a plurality of interfaces for receiving a request for execution of the virtual service.

The virtual service may include processing of having a conversation with a user.

A virtual service provision program according to another embodiment of the present disclosure is configured to refer to a packet including data output from a communication program responsible for at least a transport layer toward a lower layer. The virtual service provision program causing a computer to execute: a step of determining whether or not a destination address of the packet matches a specific network address that is set in advance; and a step of executing a virtual service corresponding to the packet in a case where the destination address of the packet matches the specific network address.

A communication method that is executed by a computer includes: a step of referring to a packet including data output from a communication program responsible for at least a transport layer toward a lower layer; a step of determining whether or not a destination address of the packet matches a specific network address that is set in advance; and a step of executing a virtual service corresponding to the packet in a case where the destination address of the packet matches the specific network address.

### Effects of the Invention

According to the present disclosure, it is possible to provide a technology for providing various services in a highly versatile manner.

### BRIEF DESCRIPTION OF DRAWINGS

FIG. 1 is a schematic view illustrating a functional configuration example of a device according to an embodiment;

FIG. 2 is a flowchart illustrating an example of processing performed by a virtual service provision program of the device according to this embodiment;

FIG. 3 is a schematic view illustrating a hardware configuration example of the device according to this embodiment;

FIG. 4 is a schematic view illustrating a processing example of the virtual service provision program of the device according to this embodiment;

FIG. 5 is a schematic view illustrating another processing example of the virtual service provision program of the device according to this embodiment;

FIG. 6 is a schematic view illustrating still another processing example of the virtual service provision program of the device according to this embodiment;

FIG. 7 is a schematic view illustrating an example of virtual device setting of the virtual service provision program of the device according to this embodiment;

FIG. 8 is a schematic view illustrating a further still another processing example of the virtual service provision program of the device according to this embodiment; and

FIG. 9 is a schematic view illustrating another functional configuration example of the device according to this embodiment.

### MODE(S) FOR CARRYING OUT THE INVENTION

An embodiment according to the present disclosure will be described in detail with reference to the accompanying drawings. Note that, the same reference will be given to the same or equivalent portion in the drawings, and description thereof will not be repeated.

### A. Terminology

In this specification, a terminology of “device” includes any information processing devices capable of performing communication processing. The device includes, for example, (fixed type and portable type) personal computers, smartphones, tablets, smartphones, wearable devices mounted on a user's body (for example, an arm, a head, or the like) (for example, smart watches, AR glasses, or the like), smart home appliances, connected automobiles, control devices installed in factories, or the like, IoT devices, and the like.

In this specification, a “network address” represents identification information for specifying a device existing on a network, and is not limited to commonly used IP (Internet Protocol) addresses (IPv4 and IPV6), but may also be a unique address system (in which an address length of any length can be employed).

In this specification, a “program” represents a computer-readable code group (stored in a medium) and also represents a state in which the program is executed by a processor. That is, the terminology “program” may include not only the code stored in a medium, but also data expanded in a memory and functions and processes realized by executing the program by a processor. However, some or all of the functions and processes realized by executing the program by the processor may be alternatively realized by using hardwired circuits such as an ASIC (Application Specific Integrated Circuit) or an FPGA (Field-Programmable Gate Array).

In this specification, a terminology a “virtual service” includes any processing that is executed within a device. At least a part of processing results (primary information) by the “virtual service” or at least a part of results (secondary information) obtained by performing some processing on the processing results may be responded to a transmission source.

### B. Overview

First, an overview of a device 100 according to this embodiment will be described.

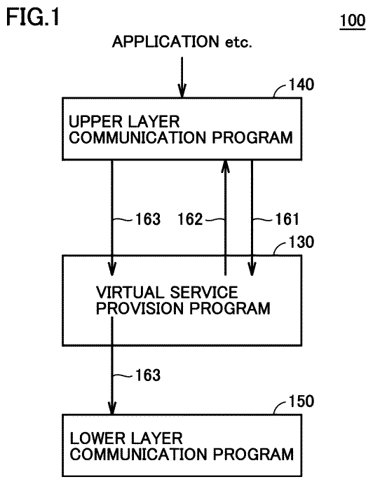

FIG. 1 is a schematic view illustrating a functional configuration example of the device 100 according to this embodiment. FIG. 1 shows a main portion of processing of transmitting and receiving data by an application (for example, corresponding to an application layer (a seventh layer) of an OSI (Open Systems Interconnection) reference model) executed on the device 100, and the like.

Referring to FIG. 1, the device 100 includes a virtual service provision program 130, an upper layer communication program 140, and a lower layer communication program 150. The upper layer communication program 140 and the lower layer communication program 150 may be included at a part of an OS (Operating System).

The upper layer communication program 140 is responsible for a transport layer (fourth layer) of the OSI reference model. The upper layer communication program 140 may be further responsible for a network layer (third layer) of the OSI reference model.

As an example, the upper layer communication program 140 may be a program responsible for socket communication. In this case, the upper layer communication program 140 is responsible for session management of a TCP (Transmission Control Protocol) and a UDP (User Datagram Protocol) which function as a transport layer, and is responsible for managing transmission and reception of packets based on a network address (for example, IP address).

The upper layer communication program 140 may be implemented as an interface of the socket communication.

The lower layer communication program 150 is responsible for a data link layer (second layer) of the OSI reference model. As an example, the lower layer communication program 150 may be implemented as a data link driver. The lower layer communication program 150 may be an Ethernet (registered trademark) interface. Note that, the lower layer communication program 150 controls a hardware interface of a physical layer (not illustrated).

Data output from the upper layer communication program 140 to a lower layer is made into a “packet” by the network layer (third layer), and is also referred to as a “packet” in the following description. That is, in this specification, the “packet” includes data output from the upper layer communication program 140 to the lower layer. However, depending on the implementation, the data may not be a complete packet, but even in such a case, the data may be within the technical scope of the invention. In addition, the terminology “packet” includes one or a plurality of packets.

In a virtual environment provided on a hypervisor, the data link layer and the physical layer may be virtualized, and in such a case, the data link layer may not exist. Therefore, the technical scope of the invention may also include a configuration in which the lower layer communication program 150 does not exist. However, even in such a virtual environment, packets may be generated internally.

In the following description, description will be mainly given of a configuration example in which the upper layer communication program 140 is also responsible for the network layer (third layer), but the virtual service provision program 130 or another communication program may be responsible for the network layer (third layer).

The virtual service provision program 130 can refer to at least packets including data output (internally) from the upper layer communication program 140 to a lower layer. Note that, the virtual service provision program 130 may or may not be able to refer to received data (received packets) transmitted or output from the lower layer to the upper layer communication program 140.

In a case where a destination address of a packet transmitted from the upper layer communication program 140 to the lower layer communication program 150 matches a specific network address set in advance, the virtual service provision program 130 executes a virtual service corresponding to the packet. A packet whose destination address does not match the specific network address set in advance is transmitted directly to the lower layer communication program 150.

Note that, FIG. 1 illustrates an example of a configuration in which the virtual service provision program 130 is placed on a transmission route from the upper layer communication program 140 to the lower layer communication program 150, but a path for transmitting a copy of a packet transmitted from the upper layer communication program 140 to the virtual service provision program 130 may be prepared in addition to the transmission route from the upper layer communication program 140 to the lower layer communication program 150.

For example, the upper layer communication program 140 responds to a packet whose destination address is a specific network address and executes a virtual service corresponding to the packet. The upper layer communication program 140 responds to a transmission source of the packet with an execution result of the virtual service (primary information and/or secondary information) as necessary.

As an example, the upper layer communication program 140 generates and transmits a packet 161 in response to a request from an upper layer such as an application. When a destination address of the packet 161 is a specific network address, the virtual service provision program 130 executes the virtual service, and transmits a response packet 162 including an execution result to the upper layer communication program 140.

On the other hand, when the destination address of the packet 163 generated by the upper layer communication program 140 does not correspond to the specific network address, the packet 163 is transmitted directly to the lower layer communication program 150.

In this way, in a case where a destination address of a packet to be transmitted matches a specific network address set in advance, the upper layer communication program 140 executes a virtual service corresponding to the packet.

### C. Processing Overview

Next, an overview of processing executed by the device 100 according to this embodiment will be described.

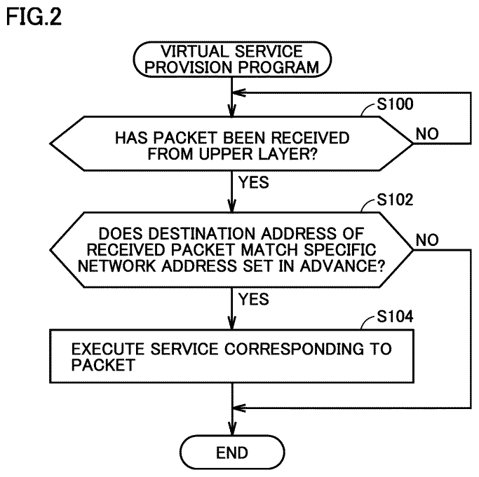

FIG. 2 is a flowchart illustrating an example of processing executed by the virtual service provision program 130 of the device 100 according to this embodiment. Each step shown in FIG. 2 may be realized, for example, by executing the virtual service provision program 130 by a processor of the device 100.

Referring to FIG. 2, when receiving a packet from an upper layer (YES in step S100), the device 100 determines whether or not a destination address of the received packet matches a specific network address set in advance (step S102).

When the destination address of the received packet matches the specific network address (YES in step S102), the device 100 executes a virtual service corresponding to the packet (step S104). Then, the processing is terminated.

When the destination address of the received packet does not match the specific network address (NO in step S102), the processing in step S104 is skipped.

### D. Example of Hardware Configuration of Device 100

Next, an example of a hardware configuration of device 100 according to this embodiment will be described.

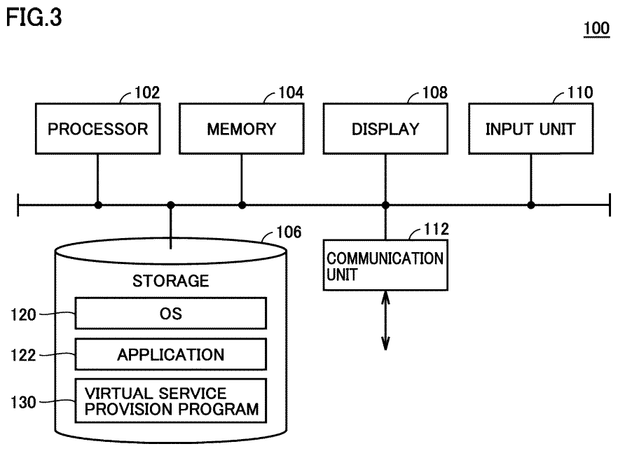

FIG. 3 is a schematic view illustrating an example of the hardware configuration of device 100 according to this embodiment. FIG. 3 illustrates an example of the hardware configuration of device 100, which is a personal computer, as an example.

Referring to FIG. 3, the device 100 includes one or a plurality of processors 102, a memory 104, a storage 106, a display 108, an input unit 110, and a communication unit 112 as a hardware configuration.

The processor 102 is an arithmetic operation circuit that sequentially reads and executes computer-readable instructions. The processor 102 is constituted by, for example, a CPU (Central Processing Unit), an MPU (Micro Processing Unit), a GPU (Graphics Processing Unit), or the like. The device 100 may include a plurality of the processors 102, or a single processor 102 may include a plurality of cores.

The processor 102 may include not only a processor in a narrow sense, but also hard-wired circuits such as an ASIC in which a circuit for realizing processing is formed in advance, and an FPGA in which a configuration for realizing processing is realized by configuration. Furthermore, in this specification, the processor 102 may also include a SoC (System on Chip) that integrates various processing elements. Therefore, the processor 102 can also be referred to as a processing circuitry.

The memory 104 is, for example, a volatile storage device such as a DRAM (Dynamic Random Access Memory) or an SRAM (Static Random Access Memory). The storage 106 is, for example, a non-volatile storage device such as an HDD (Hard Disk Drive) or an SSD (Solid State Drive).

The storage 106 stores various programs and various pieces of data. The processor 102 develops designated programs among the various programs stored in the storage 106 onto the memory 104 and sequentially executes the programs to realize various processes as described below.

As an example, the storage 106 stores an OS 120, one or a plurality of applications 122, and a virtual service provision program 130. The OS 120 is a program that provides an environment for executing various processes on the device 100. The application 122 is a program that is created arbitrarily depending on the purpose, and includes, for example, an application that provides a web browser. The virtual service provision program 130 is a program for realizing various processes as described below.

The display 108 presents results of processing performed by the processor 102 to the outside. The display 108 may be, for example, an LCD (Liquid Crystal Display), an organic EL (Electro-Luminescence) display, or the like. The display 108 may be a head-mounted display that is worn on a user's head, or a projector that projects an image onto a screen. The display 108 may be an indicator disposed at any position on a casing of the device 100.

The input unit 110 receives a user operation and the like with respect to the device 100. The input unit 110 may be, for example, a keyboard, a mouse, a touch panel disposed on the display 108, a switch disposed at any position on the casing of the device 100, or the like.

The communication unit 112 includes hardware that performs communicating with another device 100. The communication unit 112 is a network interface for connecting the device 100 to a network. For example, the communication unit 112 includes a wired connection terminal such as an Ethernet (registered trademark) port, a USB (Universal Serial Bus) port, a serial port such as IEEE 1394, and a legacy parallel port. Alternatively, the communication unit 112 may include a processing circuitry and an antenna for wireless communication with a device, a router, a mobile base station, and the like. The wireless communication to which the communication unit 112 corresponds may be, for example, any of Wi-Fi (registered trademark), Bluetooth (registered trademark), ZigBee (registered trademark), LPWA (Low Power Wide Area), GSM (registered trademark), W-CDMA, CDMA200, LTE (Long Term Evolution), and a fifth generation mobile communication system (5G).

The device 100 may further include a component for reading various programs and/or various pieces of data from a non-transitory medium in which various programs (computer-readable instructions) and/or various pieces of data are stored. The medium may be, for example, an optical medium such as a DVD (Digital Versatile Disc) or a semiconductor medium such as a USB memory.

Instead of installing the various programs and/or various pieces of data in the device 100 via the medium, necessary programs and data may be installed in the device 100 from a distribution server on a network.

The configuration for realizing a function and processing according to this embodiment is not limited to the hardware configuration example illustrated in FIG. 3, and any hardware configuration according to the era in which the hardware configuration is realized may be employed.

### E. Virtual Service Provision Program 130

Next, an example of a virtual service provided by the virtual service provision program 130 of the device 100 according to this embodiment will be described.

### e1: Example of Virtual Service

The virtual service provision program 130 of the device 100 according to this embodiment can provide one or a plurality of virtual services. Contents of the virtual service are not limited in any way. However, for example, a management service for providing and setting information related to communication processing, a proxy service for executing various processes in correspondence with a request from the application 122, and the like are assumed.

Below, some examples of the virtual service will be described.

### e2: Inquiry of Network Address

For example, the application 122 may need a network address of a host device to communicate with another device 100. In such a case, the application 122 may inquire the virtual service provision program 130 about the network address of the host device. In other words, as an example of the management service, the application 122 may respond with the network address of the host device.

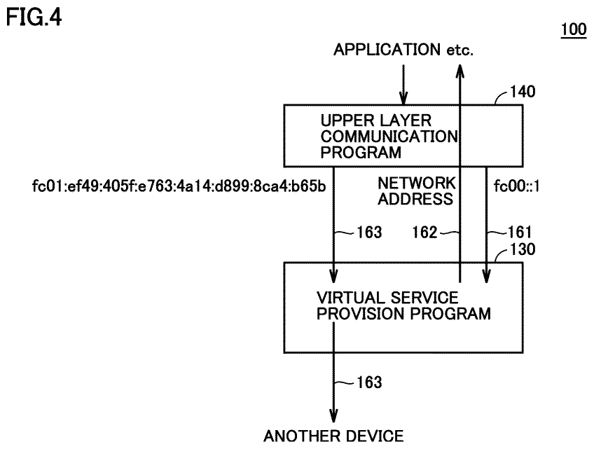

FIG. 4 is a schematic view illustrating an example of processing of the virtual service provision program 130 of the device 100 according to this embodiment.

Referring to FIG. 4, the virtual service provision program 130 sets a specific network address for providing a virtual service that responds with the network address of the host device in advance. In the example illustrated in FIG. 4, the specific network address is “fc00:1”.

When desiring to obtain the network address of the host device, the application 122 makes a request for the upper layer communication program 140 to generate and transmit a packet 161 whose destination address is “fc00::1”. When determining that the destination address of the generated packet 161 matches a specific network address set in advance, the virtual service provision program 130 executes a virtual service corresponding to the network address “fc00::1” (in this example, provision of the network address of the host device). Then, the virtual service provision program 130 responds to the application 122 via the upper layer communication program 140 with a response packet 162 including the network address of the host device obtained by executing the virtual service.

In contrast, when desiring to transmit data to another device 100, the application 122 makes a request for the upper layer communication program 140 to generate and transmit a packet 163 having a network address of the other device 100 as a destination address (for example, “fc01:ef49: 405f:e763:4a14:d899:8ca4:b65b”). When determining that the destination address of the generated packet 163 does not match a specific network address set in advance, the virtual service provision program 130 passes the packet 163 as is.

In this way, the virtual service provision program 130 provides various virtual services by performing a kind of filtering on packets in which a specific network address is set as a destination address. In addition, from the perspective of an upper layer side such as the application 122, the virtual service provision program 130 appears to be a virtual device having a specific network address. The virtual service provision program 130 can also provide one or a plurality of virtual devices.

Therefore, the virtual service provision program 130 may correspond to the network layer (third layer) of the OSI reference model. The virtual service provision program 130 functions as a virtual device having a specific network address (virtual network address), and the application 122 can exchange various pieces of information with the virtual service provision program 130 to perform communication with the other device 100.

### e3: Inquiry about Availability of Virtual Service Provision Program 130

For example, the application 122 may need to confirm whether the virtual service provision program 130 is available in the current execution environment (that is, the host device). In such a case, the application 122 may inquire of the virtual service provision program 130 as to whether the virtual service provision program 130 is available in the host device. That is, as an example of the management service, the application 122 may respond with whether the virtual service provision program 130 is available.

In this case, as in FIG. 4, the application 122 makes a request for the upper layer communication program 140 to generate and transmit the packet 161 whose destination address is a specific network address (for example, “fc00::1”). When determining that the destination address of the generated packet 161 matches the specific network address set in advance, the virtual service provision program 130 executes a virtual service corresponding to the network address “fc00::1” (for example, notifies that the virtual service provision program 130 is available). In this case, the virtual service provision program 130 responds to the application 122 via the upper layer communication program 140 with a response packet 162 to the packet 161. When the virtual service provision program 130 exists, since the virtual Service provision program 130 is usually available, it is sufficient to simply transmit the response packet 162 without performing any special processing.

On the other hand, in a case where the virtual service provision program 130 does not exist, since the response packet 162 cannot be transmitted, the application 122 can determine that the virtual service provision program 130 is not available.

As described above, since the application 122 can confirm in advance whether the virtual service provision program 130 is available, it is possible to make implementation of start conditions of the communication processing easy.

### e4: Acquisition/Search of a List of Network Addresses

For example, when communicating with a plurality of the devices 100 by using network addresses, it may be necessary to acquire network addresses that can be selected as destinations in advance. Therefore, the virtual service provision program 130 may provide a list of network addresses that are known to be selectable as destinations. Alternatively, the virtual service provision program 130 may respond with a network address that matches a designated search condition among the network addresses acquired in advance. In other words, as an example of the management service, it may be possible to perform acquisition and search for a list of network addresses.

For example, the application 122 makes a request for the upper layer communication program 140 to generate and transmit the packet 161 whose destination address is a specific network address (for example, “fc00::1”). At this time, the packet 161 may include a command for acquiring a list of network addresses, or may include a command for searching for a network address that matches a search condition among the acquired network addresses.

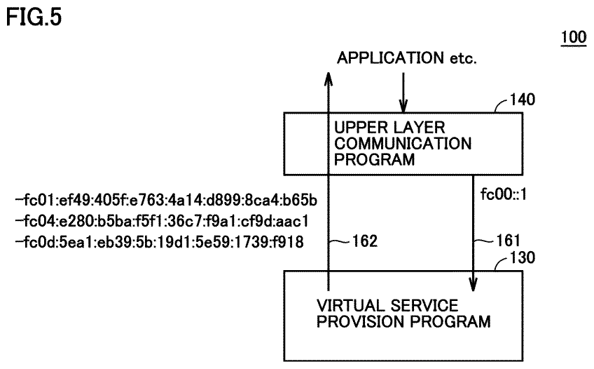

FIG. 5 is a schematic view illustrating another example of processing performed by the virtual service provision program 130 of the device 100 according to this embodiment. Referring to FIG. 5, when determining that the destination address of the generated packet 161 matches a specific network address set in advance, the virtual service provision program 130 executes a virtual service corresponding to the network address “fc00::1” (in this example, acquisition or search for a list of network addresses).

In this case, the virtual service provision program 130 has a search engine and executes the designated acquisition or search processing as a virtual service according to the command included in the packet 161. Then, the virtual service provision program 130 transmits the response packet 162 including a list of network addresses obtained by executing the virtual service, and the like.

The application 122 can determine the destination device 100 based on the list of network addresses transmitted from the virtual service provision program 130.

### e5: Management Service

The virtual service provision program 130 has various settings, and there is a need to check and change these settings from the application 122 or the like. The management service may include a service for checking and changing the settings of the virtual service provision program 130 from the application 122 or the like.

The management service may be provided via a web interface. By using the web interface, a user can check and change the settings in a conversational manner via the application 122 (for example, a web browser).

Furthermore, with regard to various information held by the virtual service provision program 130, confirmation, changing, and the like may also be performed via the application 122.

### e6: Transmission of Electronic Mail

For example, in a case of desiring to transmit an electronic mail from the application 122 or the like to a mail address, it is often necessary to make a request for an SMTP (Simple Mail Transfer Protocol) server other than the device 100 to transmit an electronic mail. The virtual service provision program 130 may transmit such electronic mail. That is, as an example of the proxy service, the virtual service provision program 130 may be able to transmit an electronic mail on behalf of the device 100.

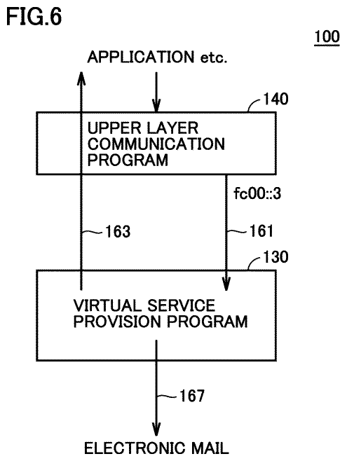

FIG. 6 is a schematic view illustrating still another processing example of the virtual service provision program 130 of the device 100 according to this embodiment. Referring to FIG. 6, when determining that the destination address of the generated packet 161 matches a specific network address set in advance, the virtual service provision program 130 executes a virtual service (in this example, transmission of an electronic mail) corresponding to the network address “fc00::3”.

In this case, the virtual service provision program 130 is configured to function as a kind of SMTP Server, and transmits an electronic mail 164 to a designated mail address according to data included in the packet 161.

The virtual service provision program 130 may transmit the packet 163 including a transmission log or the like of the electronic mail 164 to a transmission source of the packet 161.

The proxy service is not limited to transmission of an electronic mail, and includes any service such as data transfer by FTP (File Transfer Service), transmission of an SMS (Short Message Service), and proxy access to any network service. In this way, the proxy service may include processing of transmitting data to the outside the device 100.

Note that, the virtual service provision program 130 may use the lower layer communication program 150 (not illustrated) to transmit an electronic mail.

### e7: Interface

As described above, the virtual service provision program 130 can provide a plurality of virtual services. Here, a plurality of interfaces for receiving requests for execution of the virtual services may be prepared. That is, the virtual service provision program 130 may include a plurality of interfaces for receiving requests for execution of the virtual services.

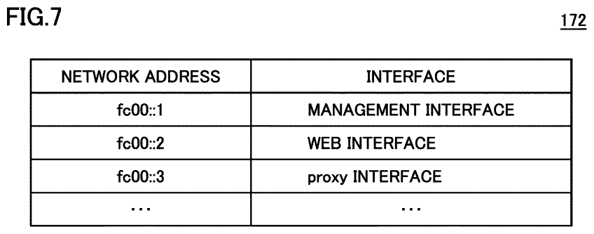

FIG. 7 is a schematic view illustrating an example of a virtual device setting 172 of the virtual service provision program 130 of the device 100 according to this embodiment.

Referring to FIG. 7, the virtual device setting 172 includes, for example, setting of an interface for using the virtual service and a corresponding network address. In the example illustrated in FIG. 7, a management interface, a web-based interface, and a proxy interface are prepared.

More specifically, in the example illustrated in FIG. 7, when receiving a packet whose network address is “fc00::1” set as a destination address, the virtual service provision program 130 executes a management service based on the received packet.

When receiving a packet whose network address is “fc00::2” set as a destination address, the virtual service provision program 130 operates as a kind of web server. Note that, the virtual service provision program 130 executes the management service or the proxy service in correspondence with a designated URL or command.

When receiving a packet whose network address is “fc00::3” set as the destination address, the virtual service provision program 130 executes a proxy service.

In this way, the virtual service provision program 130 can prepare a plurality of network addresses for providing virtual services. In this case, the virtual service provision program 130 has a plurality of specific network addresses for executing a service based on the received packet.

The interface for making a request for execution of a virtual service from the application 122 or the like may be designed in any way without limitation to the example of the interface setting illustrated in FIG. 7.

The above-described management interface and proxy interface may support, for example, a remote procedure call (RPC). In this case, a packet in which a specific network address is set as a destination address may contain a command for calling a subroutine or procedure prepared in the virtual service provision program 130. The virtual service provision program 130 may also respond with a result of processing and execution in accordance with the command included in the packet.

For example, a packet in which a specific network address is set as a destination address may include a subroutine name or a procedure name for acquiring a network address of a host device. For example, when calling a subroutine or a procedure called “Whoami”, “fc00::1//Whoami” may be designated in the application 122.

In addition, in order to realize the above-described web interface, the virtual service provision program 130 may have httpd (HyperText Transfer Protocol Daemon). In this case, a packet in which a specific network address is set as a destination address may be generated and transmitted according to HTTP (Hypertext Transfer Protocol), and the virtual service provision program 130 may respond in accordance with the HTTP.

For example, when a script for acquiring necessary information from the virtual service provision program 130 is set to “GetAddress.js”, a URL such as “https://fc00::2/GetAddress.js” may be designated from the application 122.

### e8: User Interaction

The virtual service provision program 130 can execute a requested virtual service, and can also have a conversation with a user (user interaction) as a part of the virtual service.

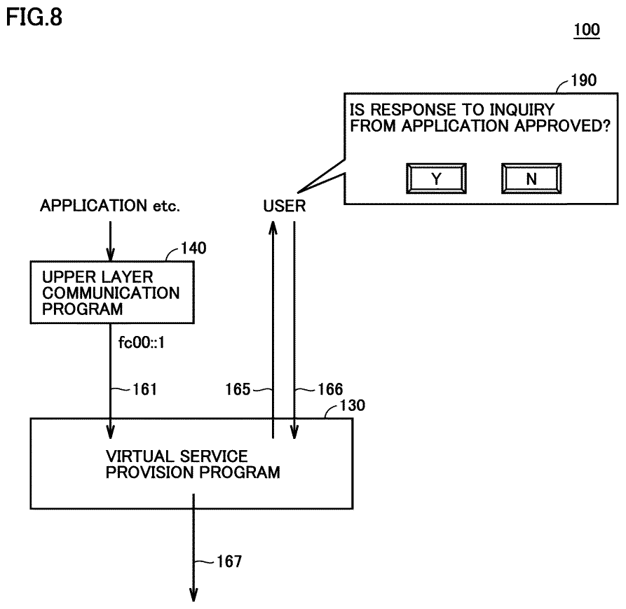

FIG. 8 is a schematic view illustrating a further still another processing example of the virtual service provision program 130 of the device 100 according to this embodiment. Referring to FIG. 8, the virtual service provision program 130 receives a packet 161 in which a destination address is set to a specific network address, and transmits a command 166 for providing a user interface screen 190 when executing the virtual service according to the received packet 161.

The command 166 includes information for providing the user interface screen 190. The command 166 may be transmitted, for example, to an OS or the application 122. Any command 166 for providing the user interface screen 190 can be generated in correspondence with a program execution environment of the device 100.

The virtual service provision program 130 may provide the user interface screen 190 in any implementation. For example, an API (Application Programming Interface) provided by the OS may be used, or the virtual service provision program 130 may directly generate the user interface screen 190.

The virtual service provision program 130 acquires an instruction 168 input by a user by operating the user interface screen 190. The user interface screen 190 illustrated in FIG. 8 is configured to make a request for a user's agreement. When the user agrees, the virtual service provision program 130 continues the virtual service. For example, the virtual service provision program 130 may continue the virtual service and access a designated destination 167.

On the other hand, when the user does not agree, the virtual service provision program 130 may interrupt the virtual service.

In this way, the virtual service provision program 130 can provide a virtual service having a conversation with the user. That is, the virtual service may include processing of having a conversation with the user. The frequency, timing, or the like of the conversation with the user can be designed in any manner.

For convenience of explanation, FIG. 8 illustrates an example of a conversation with a user by using a graphical user interface, but the conversation with the user may be realized by using a character user interface. That is, any user interface may be used for the conversation with the user.

### e9: Event Execution of Virtual Service Provision Program 130

In the above-described processing example illustrated in FIG. 8, the virtual service provision program 130 provides the user interface screen 190 in response to a request from the application 122 or the like. However, the virtual service provision program 130 may provide the user interface screen 190 when any condition is satisfied.

For example, the virtual service provision program 130 may provide the user interface screen 190 when any event occurs. The event may include, for example, occurrence of a situation in which processing that requires a user's approval should be executed, occurrence of a situation in which any notification should be given to the user, or the like.

In this way, the virtual service provision program 130 can provide an independent virtual service without depending on the application 122 or the like.

### e10: Implementation of Application

In the device 100, any application 122 can use the virtual service provision program 130. The application 122 may be generated by building any project, or may be a source code (for example, written in JavaScript (registered trademark)) executed on a web browser.

As described above, the virtual service provision program 130 functions as a virtual device having a specific network address. Therefore, the application 122 only needs to be implemented so that the specific network address can be designated as a destination, and there are fewer constraints on implementation.

### e11: Others

The functions and processing provided by the virtual Service provision program 130 described above can be combined in any way.

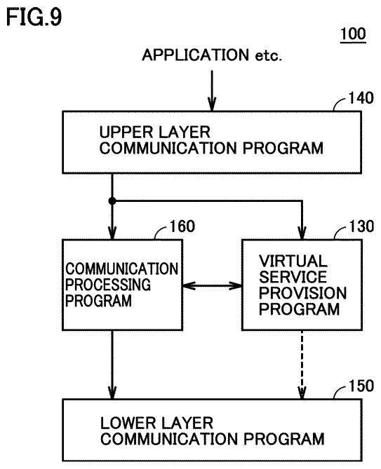

FIG. 9 is a schematic view illustrating another example of the functional configuration of the device 100 according to this embodiment. Referring to FIG. 9, the device 100 may include a communication processing program 160 in parallel with the virtual service provision program 130.

The communication processing program 160 may be, for example, a program that executes processing of obtaining an authenticated network address.

In the example illustrated in FIG. 9, a packet generated and transmitted by the upper layer communication program 140 is transmitted to both the virtual service provision program 130 and the communication processing program 160. The virtual service provision program 130 processes only packets whose destination address matches a specific network address, and the communication processing program 160 executes communication processing according to the destination of the packet. Note that, when the specific network address is a virtual address, the packet cannot be transmitted on an actual network, and thus actual communication processing is not performed.

In a case where the virtual service provision program 130 should execute processing of transmitting data to the outside of the device 100, the virtual service provision program 130 and the communication processing program 160 may exchange information so that the virtual service provision program 130 can entrust the processing to the communication processing program 160.

In addition, the virtual service provision program 130 may execute independent communication processing. In this case, the virtual service provision program 130 may use the lower layer communication program 150.

In addition, the virtual service provision program 130 and the communication processing program 160 may be integrated with each other. In this case, processing of either the virtual service provision program 130 or the communication processing program 160 is selected in correspondence with a destination of a received packet.

Furthermore, the virtual service provision program 130 may be implemented as a part of any program instead of the communication processing program 160.

### F. Advantages

According to the network system according to this embodiment, with respect to a packet designated as a destination for a specific network address, information corresponding to a request included in the packet is provided, and thus the information can be used to enrich processing.

The embodiment disclosed herein should be considered to be illustrative only and not restrictive in all respects. The scope of the invention is defined by the appended claims not the above description, and is intended to include all modifications within the meaning and scope equivalent to the appended claims.

### EXPLANATIONS OF LETTERS OR NUMERALS

100 DEVICE, 102 PROCESSOR, 104 MEMORY, 106 STORAGE, 108 DISPLAY, 110 INPUT UNIT, 112 COMMUNICATION UNIT, 120 OS, 122 APPLICATION, 130 VIRTUAL SERVICE PROVISION PROGRAM, 140 UPPER LAYER COMMUNICATION PROGRAM, 150 LOWER LAYER COMMUNICATION PROGRAM, 160 COMMUNICATION PROCESSING PROGRAM, 161, 163 PACKET, 162 RESPONSE PACKET, 164 ELECTRONIC MAIL, 166 COMMAND, 167 ACCESS, 168 INSTRUCTION, 172 VIRTUAL DEVICE SETTING, 190 USER INTERFACE SCREEN.

1. An information processing device, comprising:
a communication program responsible for at least a transport layer; and
a virtual service provision program capable of referring to a packet including data output from the communication program toward a lower layer,
wherein in a case where a destination address of the packet matches a specific network address that is set in advance, the virtual service provision program executes a virtual service corresponding to the packet.

2. The information processing device according to claim 1,
wherein the virtual service provision program responds with at least a part of execution results of the virtual service as information.

3. The information processing device according to claim 1,
wherein the virtual service includes processing of transmitting data to outside of the information processing device.

4. The information processing device according to claim 1,
wherein the virtual service provision program has a plurality of the specific network addresses.

5. The information processing device according to claim 1,
wherein the virtual service provision program has a plurality of interfaces for receiving a request for execution of the virtual service.

6. The information processing device according to claim 1,
wherein the virtual service includes processing of having a conversation with a user.

7. A non-transitory storage medium storing thereon a virtual service provision program configured to refer to a packet including data output from a communication program responsible for at least a transport layer toward a lower layer, the virtual service provision program causing a computer to execute:
a step of determining whether or not a destination address of the packet matches a specific network address that is set in advance; and
a step of executing a virtual service corresponding to the packet in a case where the destination address of the packet matches the specific network address.

8. A communication method that is executed by a computer, comprising:
a step of referring to a packet including data output from a communication program responsible for at least a transport layer toward a lower layer;
a step of determining whether or not a destination address of the packet matches a specific network address that is set in advance; and
a step of executing a virtual service corresponding to the packet in a case where the destination address of the packet matches the specific network address.
